(19) United States
(12) Patent Application Publication
(10) Pub. No.: US 2008/0025630 A1
(43) Pub. Date: Jan. 31, 2008

(54) ADAPTIVE NOISE FILTERING FOR REDUCING IMAGER NOISE IN DIGITAL IMAGE APPLICATIONS

(75) Inventors: Clifford S. Hofman, Cary, NC (US); Hesham I. Mahmoud, Cary, NC (US); Anastassios Markas, Cary, NC (US)

Correspondence Address: SCHNECK & SCHNECK, P.O. BOX 2-E, SAN JOSE, CA, 95109-0005, US

(73) Assignee: ATMEL CORPORATION, San Jose, CA (US)

(21) Appl. No.: 11/460,759

(22) Filed: Jul. 28, 2006

(51) Int. Cl. G06K 9/40

(52) U.S. Cl. 382/260

(57) ABSTRACT

A noise filtering engine and method that removes fixed and random pattern noise from a digital image source. The engine may be implemented, for example, as a subsystem of a hardware-based pipeline for digital image processing or in software or a combination of hardware and software. The noise reduction engine consists of one or more hardware blocks to facilitate high throughout and high-performance operations. The engine has a significant degree of flexibility and programmability allowing, for example, digital camera manufacturers to implement the noise reduction engine in medium to high-end cameras operating with various types of imagers including CCD and CMS image sensors.

### TECHNICAL FIELD

The present invention relate to filtering digital images and specifically to providing filtering for reducing image noise in a digital camera.

### BACKGROUND ART

Digital image acquisition devices inherently introduce noise into an acquired image. The introduction of noise is especially enhanced by the digital acquisition device sensor. Noise not only degrades image quality but reduces efficiency for any subsequent encoding or compression steps. Encoding or compression typically operates in accordance with, for example, an MPEG or JPEG standard or one of a plurality of international standards promulgated by the International Telecommunications Union (ITU) such as the H.263 standard common in videoconferencing. The MPEG, JPEG, and ITU standards are all widely employed in digital imaging devices in contemporary commercial and industrial usage.

Various approaches exist to remove noise from digital images; however, most methods make use of spatial filtering techniques. One class of noise reduction spatial filters applies a non-linear localized spatial filtering technique directly to a digital image. An example of such a noise reduction filter is a simple sigma filter, described by Jong Sen Lee in the journal article “Digital Image Smoothing and the Sigma Filter,” Computer Vision, Graphics, and Image Processing Vol. 24, p. 255-269, 1983. The sigma noise reduction filter uses a non-linear pixel averaging technique sampled from a rectangular window. The window is comprised of neighboring pixels surrounding a center pixel. Neighboring pixels are either included or excluded from the numerical averaging process based on a difference between one or more neighboring pixels and the center pixel. The small local neighborhood of pixels used by the sigma filter make it simple to implement and relatively effective at removing high spatial frequency components of noise. However, many noise sources, such as Gaussian sources, contain broadband frequency components.

Gaussian noise sources exhibit random noise fluctuations over a large range of spatial frequencies. The sigma filter is generally capable of only removing high spatial frequency components of noise and thus has difficulty removing low spatial frequency components associated with Gaussian noise. The low-pass filtering effect of the sigma filter is largely due to the filter operating on only a small local neighborhood of pixels. Therefore, lower spatial frequency components of noise are not removed. A resultant digital image processed with the sigma filter can thus have a mottled appearance, particularly noticeable for sky regions or other continuous-tone regions that have little image structure.

Most advanced filters, such as multiresolution or pyramid methods, also filter images as a function of spatial resolution. One method of representing a digital image by a series of residual images and a base digital image is described in a journal article entitled, “The Laplacian Pyramid as a Compact Image Code,” IEEE Transactions on Communications, Vol. Com-3 1, No. 4, April 1983. Although the multiresolution method was primarily designed for image compression methodologies, the method has been used in applications for noise reduction filtering.

The multiresolution method generally relies on removing noise from a digital image by determining a series of calculation-intensive Discrete Cosine Transform (DCT) coefficients for an image. The calculated DCT coefficients are filtered with a Wiener noise filter and a reduced noise digital image is reconstructed. The multiresolution method thus removes noise from the digital image at different spatial frequencies by operating on calculation-intensive DCT coefficients (i.e., residual images).

A wavelet spatial frequency decomposition method has also been employees the use of removing noise from digital images. U.S. Pat. No. 5,526,446 to Adelson et al. discloses a technique which converts an image decomposition process followed by a modification of each coefficient based on its value and a value of coefficients of related orientation, position, or scale. While the method disclosed by Adelson et al. is capable of removing both low frequency and high frequency noise, the described method must be applied to a set of multi-scale coefficients and cannot be directly applied to a digital image.

Overall, digital image noise is generally exhibited throughout a broad range of spatial frequencies. The sigma filter can effectively remove only the highest spatial frequency components of noise. Other methods may be more effective at removing broadband noise but are computationally-intensive and, consequently, slow.

Though the known techniques for reducing noise in image sequences are satisfactory in many respects, they are also associated with numerous drawbacks and problems that are bound up with, for example, inadequate performance, processing complexity, and excessive processing costs that make employment of such techniques difficult, especially in portable image acquisition devices such as digital cameras.

### SUMMARY

In an exemplary embodiment, the present invention is a noise filtering engine for enhancing an applied digital image source. The noise filtering engine includes a data collection phase element, a determination phase element, and an application phase element.

The data collection phase element accepts an image from the applied digital image source and determines characteristics of a pixel under evaluation within the digital image source.

A determination phase element is coupled to an output of the data collection phase element and determine whether the pixel under evaluation requires filtering. After the determination phase element is completed, a determination is made whether to apply filtering. If so, the image processing continues onto an application phase.

An application phase element receives output data from the determination phase element and applies a smoothing function based upon characteristics of the pixel under evaluation. Alternatively, a value of the pixel under evaluation may be replaced by another value, previously calculated. An output of the application phase element is an enhanced digital image.

### BRIEF DESCRIPTION OF THE DRAWINGS

FIG. 1 shows an exemplary kernel containing a pixel under evaluation and neighboring pixels.

FIG. 2A is an exemplary noise filtering engine which accepts as the kernel of FIG. 1 from a digital image source as an input and produces an enhanced digital image as an output.

FIG. 2B is an exemplary embodiment of a data collection phase element of the noise filtering engine of FIG. 2A.

FIG. 2C is an exemplary embodiment of a determination phase element of the noise filtering engine of FIG. 2A.

FIG. 2D is an exemplary embodiment of an application phase element of the noise filtering engine of FIG. 2A.

### DETAILED DESCRIPTION

Described herein is a noise filtering engine that removes fixed and random pattern noise from a digital image source. The engine may be implemented, for example, as a subsystem of a hardware-based pipeline for digital image processing. The noise reduction engine may consist of one or more hardware blocks to facilitate high throughput and high-performance operations. The engine has a significant degree of flexibility and programmability allowing, for example, digital camera manufacturers to implement the noise reduction engine in medium to high-end cameras operating with various types of imagers including charge-coupled devices (CCDs) and complimentary metal-oxide semiconductor (CMOS) image sensors.

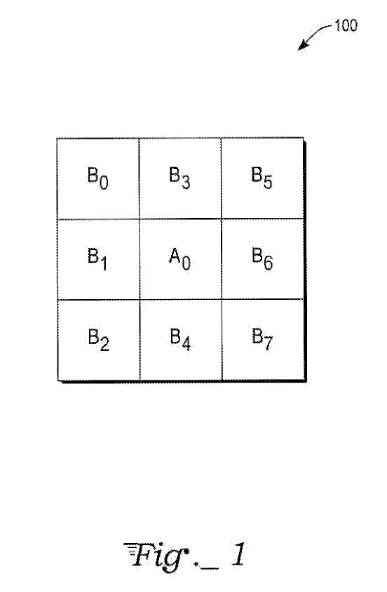

With reference to FIG. 1, an exemplary kernel 100 of a pixilated image includes nine pixels of the image comprised of a pixel under evaluation A₀, surrounded by eight nearest-neighbor pixels B₀-B₇. A skilled artisan will recognize that the kernel 100 is not limited to a 3×3 matrix of nine pixels. The nine-pixel kernel 100 is merely included as an example of how neighboring pixels B₀-B₇ may influence or affect filtering of a pixel under evaluation A₀. A noise filter and method incorporating a series of steps, calculation elements, or algorithms for filtering the pixel under evaluation A₀ is described herein. The noise filter and method can be readily adapted for use into or with microcontroller and microprocessor devices.

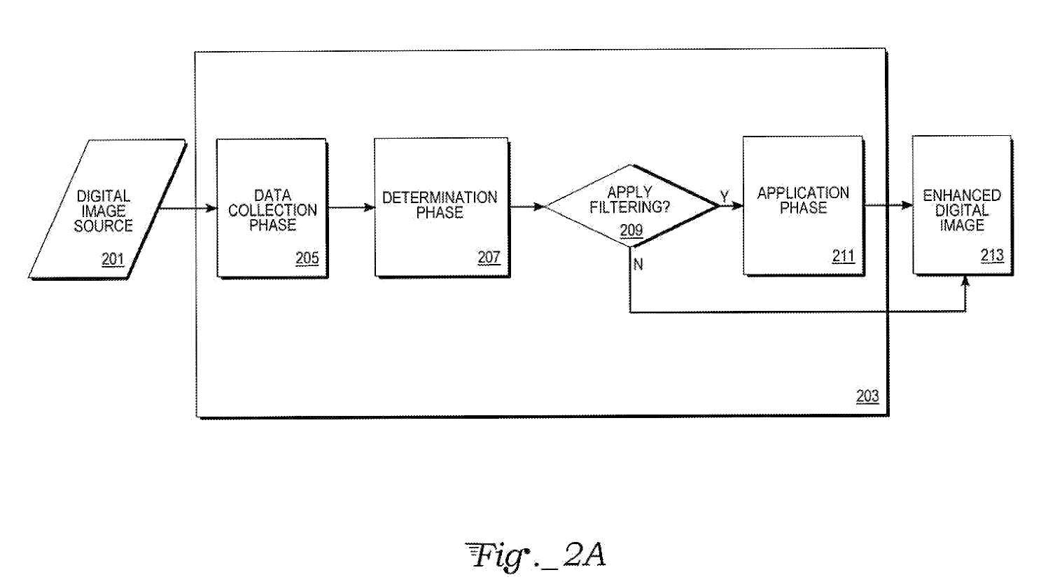

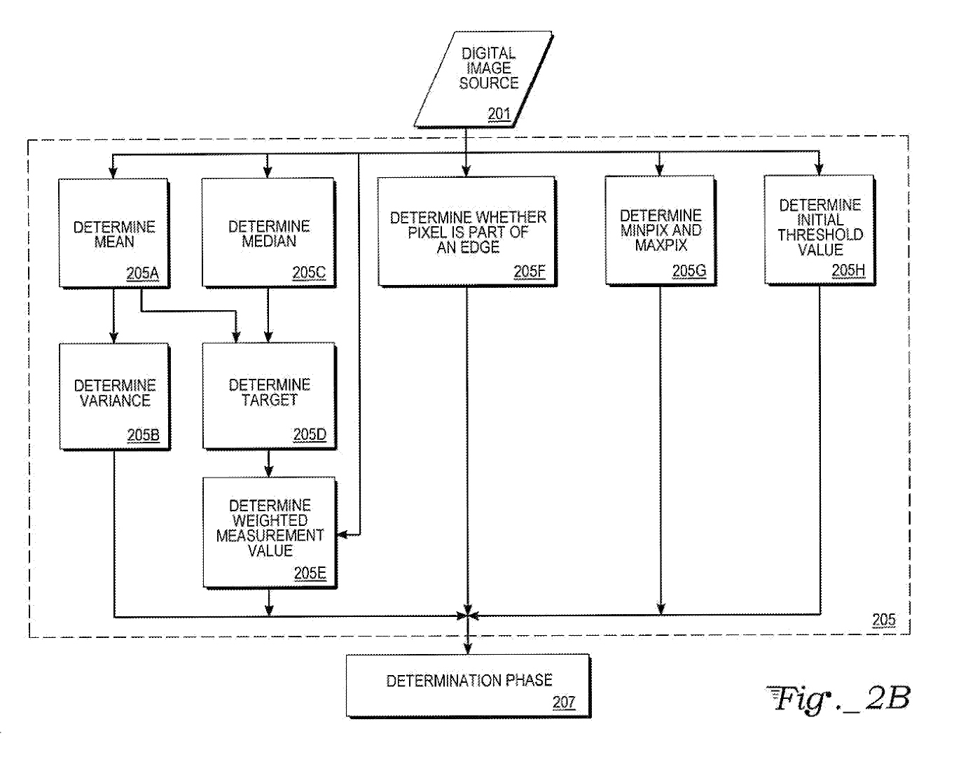

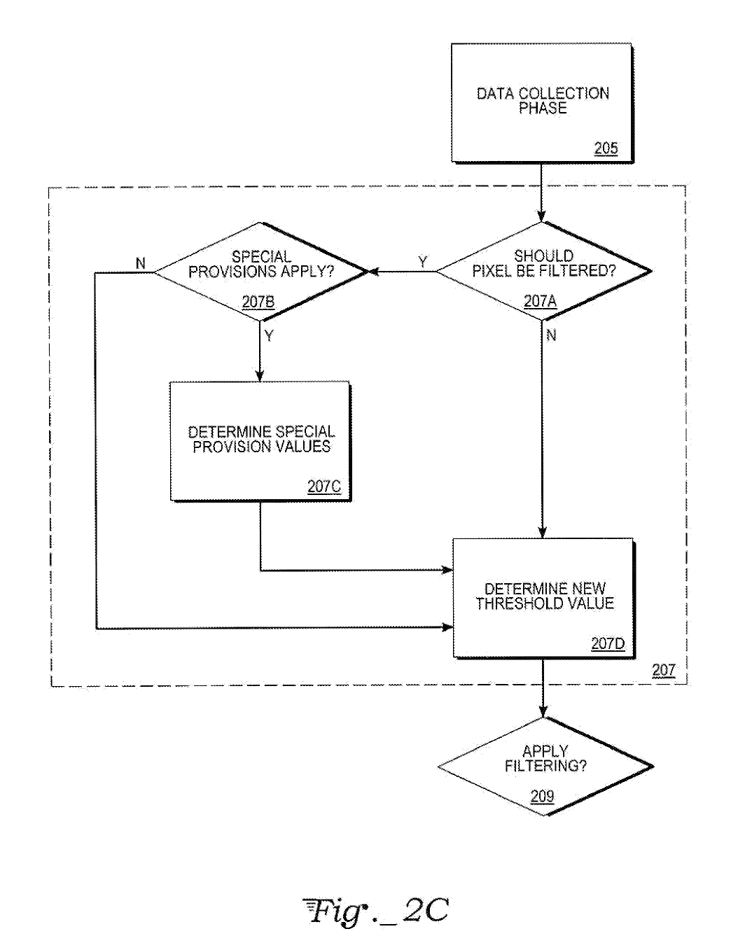

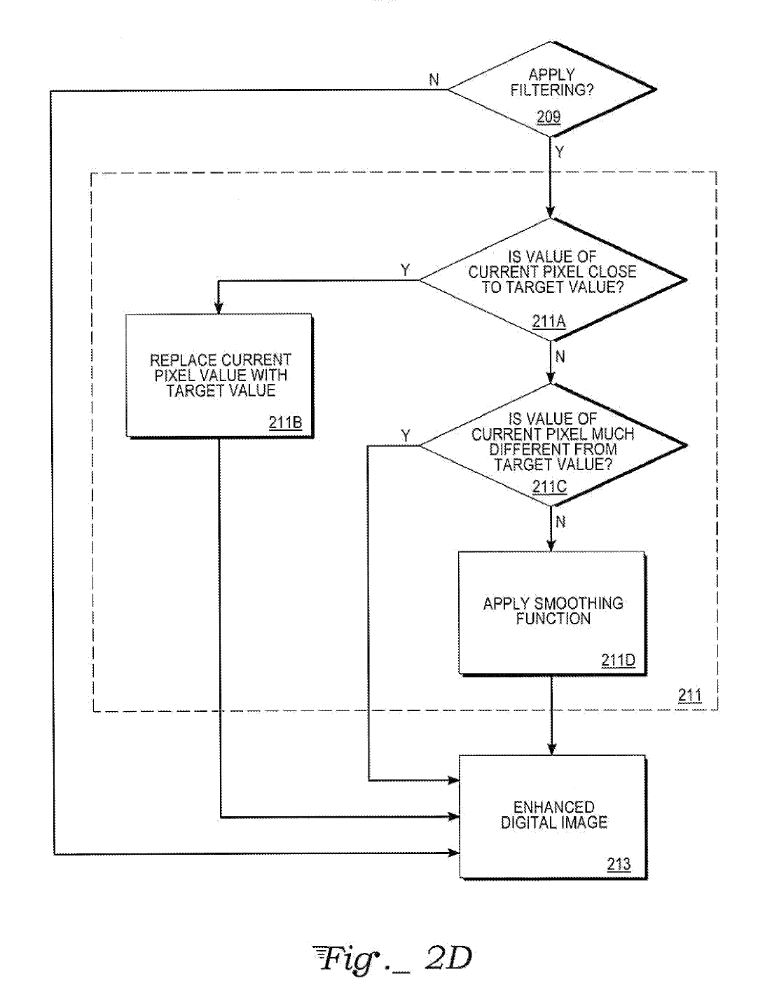

With reference to FIG. 2A, a digital image source 201, such as acquired directly from a sensor (e.g., a CCD array or CMOS sensor) or from an image file, may be spatially filtered to remove or minimize noise. The digital source image is input to a noise filtering engine 203. The noise filtering engine 203 includes a data collection phase element 205 and a determination phase element 207. After the determination phase element 207, a query 209 is made whether to apply filtering a given pixel under evaluation. If the determination is made to apply filtering, the noise filtering engine 203 continues with an application phase element 211. If either the determination is made not to apply filtering or filtering is applied to the pixel in the application phase element 211, an enhanced digital image 213 is output. A series of filtering algorithms and smoothing filters within the noise filtering engine 203 removes noise without affecting edges or other characteristics that are important contributors to an overall quality of the image. Each of the three main tasks of the noise filtering engine 203, the data collection phase element 205, the determination phase element 207, and the application phase element 211, are discussed separately in detail, infra.

### The Data Collection Phase Element

In an exemplary embodiment, various values (discussed in detail below) are computed within the noise filtering engine 203 based on measurements of the eight nearest-neighbor pixels B₀-B₇ in the kernel 100 (FIG. 1) surrounding the pixel under evaluation A₀ and combined with measurements of A₀. Various values are also computed based on a measurement of the pixel under evaluation A₀ independent of measurements of the eight nearest-neighbor pixels B₀-B₇. These computed values may be applied to other portions of the algorithms to determine where noise filtering should be applied and where filtering should not apply. In the data collection phase element 205, measurements and computed values of the eight nearest-neighbor pixels, B₀-B₇, are compared with the measurement and computed values of the pixel under evaluation A₀.

In this embodiment and with reference to FIG. 2B, computed values from the digital image source 201 include determinations of mean ( x̅) 205A, median (M_{d}) 205C, edge presence (Edge) 205F, largest (MaxPix) and smallest (MinPix) values 205G, and determination of an initial threshold value 205H of one or more pixels within the kernel 100. Each of the determinations may be implemented by combinations or independent applications of hardware, software, or firmware. The various elements of the noise filter may thus be considered to be a circuit, function, or algorithm. Each determination of a computed value is realizable by a skilled artisan applying the equations and relative structure described herein.

Once the mean value has been calculated, as discussed below, determination of variance (v) 205B may be accomplished. Also, determination of a target value 205D may be calculated from either the mean or median values. A determination of a weighted measurement value 205E may then be calculated based on the target value. Calculation or determination of each of these values is discussed in detail, infra.

Calculation of the mean value, x̅, is accomplished by considering a value, x₁, for each pixel in the kernel 100 divided by the number of total samples, n. Thus, in the case of evaluating the mean of the nine values within the kernel 100, the mean is simply the arithmetic average

$$\overline{x} = \frac{1}{n} {\sum }_{i = 0}^{n - 1} {x}_{i}$$

$$\overline{x} = \frac{1}{9} {\sum }_{i = 0}^{8} {x}_{i}$$

For a median value, M_{d}, if the sample (e.g., the kernel 100) under consideration is arranged in order of ascending magnitude, the median, M_{d}, is given by the value located at a position of

$$\frac{n + 1}{2} .$$

### When n is odd, the median value is simply the middle value of a set of ordered data; when n is even, the median may be taken as the mean of the two central values of the set of ordered data.

The edge presence, which includes strength and presence of edges, may be implemented by various algorithms and methods known to a person of skill in the art.

The largest and smallest values are simply the largest and smallest magnitude values of the pixels within the kernel 100. In a degenerate case where the largest and smallest magnitude values are the same, the difference is zero. In this case, filtering will not occur.

The threshold value (Th) is a value used in the determination phase element 207 to calculate an amount of filtering, if any, to apply to a given pixel. The threshold value is a linear modification of an existing pixel value using two programmable coefficients, α and β. Values for both coefficients are calculated by higher level appreciation software taking into consideration parameters such as lighting conditions, sensor sensitivity, and user-defined settings. Thus, the threshold, Thₒ, is determined as

Thₒ=α+β·(pixel value)

### The subscript on Thₒ becomes relevant in the determination phase element 207, infra, as a second threshold value is then determined.

Once the mean value, x̅, is determined, a variance, v, is simply the square of a standard deviation value where the standard deviation and variance are calculated as

$$v = \frac{{\sum }_{i = 1}^{n} {( {x}_{i} - \overline{x} )}^{2}}{n - 1}$$

### Alternatively, for computational purposes, v can be more readily determined by either of the following equations

$$v = \frac{{\sum }_{i = 1}^{n} {x}_{i}^{2} - n {\overline{x}}^{2}}{n - 1}$$

$$v = \frac{n {\sum }_{i = 1}^{n} {x}_{i}^{2} - {( {\sum }_{i = 1}^{n} {x}_{i} )}^{2}}{n ( n - 1 )}$$

Once calculations and determinations are made for values of average, median, edge presence, variance, and largest and smallest values of pixels in the kernel 100, additional calculations and/or determinations are made using results from those calculations. The additional calculations and/or determinations include a target value 205D, a weighted measurement value 205E, and any ancillary information (not shown) that may be needed for a given pixel.

A determination of the target value (target) 205D may simply be chosen to be either the mean or median value. Calculation of both the mean and the median values are described supra. The choice of whether to use the mean value or the median value is user-selectable depending upon application.

The weighted measurement value (Meas) is calculated as a weighted difference between the absolute difference between the target value and the current pixel value

Meas=γ·|target−pixel value|

where the weighting coefficient γ is another programmable constant. The weighting coefficient γ is calculated by higher level application software taking into consideration parameters such as lighting conditions, sensor sensitivity, and user-defined settings.

The ancillary information (not shown) includes any special information to guide a correct application of filtering and/or smoothing in subsequent steps and defines exclusions for when filtering should not be applied. If the noise filter is applied, the ancillary information also defines how the filter should be applied and which parameters should be applied to the noise filter.

### The Determination Phase Element

With reference to FIG. 2C, a determination 207A is made whether the pixel under evaluation A₀ requires filtering. If filtering should apply, a second determination 207B is then made whether any special provisions for the pixel under evaluation require special application. In a specific exemplary embodiment, criteria applied during the special provisions process include:
(a) a uniform application of filtering independently of characteristics (Unif)
(b) whether any edges exist on the kernel under examination (Edge)
(c) whether the pixel under evaluation is part of an edge (Edge)
(d) whether the variance of the kernel exceeds or is below a certain level (Var)
(e) whether a difference between the target and a value of the pixel under evaluation is either larger or smaller than a certain value; and
(f) what is the relationship of the pixel under evaluation with neighboring pixels

An overall result of the process is a binary value which indicates whether the pixel will be filtered or not. Factors determined above are used in determining 207D a new threshold value, Thₙ

Thₙ=Thₒ·[1+(Edge·d)]·[1+(|Var−e|·d)]·[1+{(MaxPix−MinPix)·f}]

where the variables d, e, and f refer to results from the steps (d), (e), and (f) given supra. A uniform value is applied when d=f=0. The variables d, e, and f are calculated by higher level application software taking into consideration parameters such as lighting conditions, sensor sensitivity, and user-defined settings. Experimentation is required for various system setups to optimize performance under various conditions. Methods for experimentation are known to one of skill in the art.

A result from the new threshold value determination 207D, Thₙ, is determined for each pixel under evaluation (e.g., in an iterative process, not shown explicitly). These results are then used in the application phase element 211.

### The Application Phase Element

With continued reference to FIG. 2A, results from the data collection phase element 205 and the determination phase element 207 are used in the application phase element 211 to filter individual pixels which have been elected as candidates for noise filtering. The application phase element 211 is thus an application of a filtering function that will be applied on the pixel under evaluation. In addition to selecting a particular filtering function, a function magnitude (e.g., strong filtering or weak filtering within a given function) is selected as well. In subsequent iterations of the application phase element 21, pixels other than the current pixel under evaluation requiring noise reduction are also filtered. Implementation of various filter types is addressed infra.

With reference to a specific exemplary embodiment of the application phase element 211 of FIG. 2D, if filtering is determined 209 to apply, the application phase element 211 includes the following steps or determinations:
(a) if a value of the current pixel under evaluation is close (“close” is defined by the interpolation equations defined herein) to the target value 211A, the current value is considered noise and the current pixel value is replaced by the target value 211B;
(b) if the current pixel value is much different than the target value 211C, the pixel is considered as having “high-information content” (e.g. such as an edge or another strong part of the image) and the current pixel value is preserved; and
(c) for any current pixel value in between those defined by steps (a) and (b), a smoothing function is applied 211D that takes into account a distance between the current pixel and the target value. The smoothing function can take several forms, such as:
   i. simple pixel replacement

FilteredPixel=Target
ii. linear interpolation

$$FilteredPixel = ( 1 - \frac{Meas}{{Th}_{n}} ) \cdot Target + ( \frac{Meas}{{Th}_{n}} ) \cdot Pixel$$

iii. quadratic interpolation

$$FilteredPixel = [ 1 - {( \frac{Meas}{{Th}_{n}} )}^{p} ] \cdot Target + [ {( \frac{Meas}{{Th}_{n}} )}^{p} ] \cdot Pixel$$

iv. n-th degree polynomial approximation

$$[ 1 - {( \frac{diff}{{Th}_{n}} )}^{p} ] \cdot Target + [ {( \frac{diff}{{Th}_{n}} )}^{p} ] \cdot curr$$

In the quadratic interpolation and the polynomial approximation, “p” may take on any integer value. After the application phase element 211, an enhanced digital image 213 is output.

In the foregoing specification, the present invention has been described with reference to specific embodiments thereof. It will, however, be evident to a skilled artisan that various modifications and changes can be made thereto without departing from the broader spirit and scope of the invention as set forth in the appended claims. For example, skilled artisans will appreciate that various calculations may be used in various combinations and permutations described herein to filter an image in certain ways. Not all calculations need to be used in all contexts. Also, implementations of the described noise filtering engine may be realized in hardware, software, or firmware or a hybrid combination of the three. For example, with regard to hardware implementations, skilled artisans will appreciate that methods described are applicable to a variety of microprocessors and microcontrollers, including load/store architectures (popularly called RISC machines) and memory-oriented architectures (traditionally called CISC machines). Each of these implementations can be realized by a skilled artisan based on principles and functions described herein. Additionally, although the noise filter has been defined primarily with regard to use with a digital camera, the filter can be incorporated for use with any digital imaging system including a flat bed, drum, or rotary scanner or a store image data file. The specification and drawings are, accordingly, to be regarded in an illustrative rather than a restrictive sense.

What is claimed is:

1. A method for filtering noise from an applied digital image source, the method comprising:
providing a plurality of pixels from the applied digital image source;
sorting groups of the plurality of pixels into one or more input kernels, the one or more input kernels each comprising a pixel under evaluation and surrounding pixels in the kernel;
determining characteristics of the pixel under evaluation based on a comparison of the pixel with one or more surrounding pixels comprising at least part of a first of the one or more kernels;
determining a mean value of the first kernel;
determining a median value of first kernel;
determining a target value based partially on the mean value and the median value of the first kernel;
determining an initial threshold value to calculate a magnitude of filtering if a determination is made to apply filtering;
determining whether the pixel under evaluation requires filtering; and
apply a smoothing function to the pixel under evaluation if a determination is made the pixel requires filtering.

2. The method of claim 1 further comprising:
determining whether the pixel under evaluation is part of an image edge; and
determining a maximum pixel value and a minimum pixel value from the first kernel.

3. The method of claim 1 further comprising:
determining a variance value based on the mean value of the first kernel; and
determining a weighted measurement value based partially on the target value.

4. The method of claim 1 further comprising:
calculating a smoothing function; and
applying the smoothing function to the pixel under evaluation

5. The method of claim1 further comprising determining whether a value of the pixel under evaluation should be replaced with the target value.

6. A noise filtering engine to enhance an applied digital image source, the engine comprising:
a data collection phase element, the data collection phase element configured to accept the applied digital image source and determine characteristics of a pixel under evaluation, the pixel under evaluation being located within the digital image source;
a determination phase element coupled to an output of the data collection phase element and configured to determine whether the pixel under evaluation requires filtering; and
an application phase element coupled to an output of the determination phase element, the application phase element configured to apply a smoothing function based upon characteristics of the pixel under evaluation, an output of the application phase element being an enhanced digital image.

7. The noise filtering engine of claim 6 wherein the data collection phase element comprises:
a mean determination element adapted to receive the applied digital image source and determine a mean value of an input kernel, the input kernel being selected from the applied digital image source and comprising the pixel under evaluation and neighboring pixels; and
a median determination element adapted to receive the digital image source and determine a median value of the input kernel.

8. The noise filtering engine of claim 7 wherein the data collection phase element further comprises:
a variance determination element coupled to receive an output from the mean determination element and supply a calculated variance value as an input to the determination phase element;
a target determination element coupled to receive an output from both the mean determination element and the median determination element; and
a weighted measurement value determination element coupled to receive as an input the applied digital image source and an output from the target determination element and supply a weighted measurement value as an input to the determination phase element.

9. The noise filtering engine of claim 6 wherein the data collection phase element comprises:
an edge determination element coupled to receive the applied digital image source and to determine whether the pixel under evaluation is part of an edge from an image contained within the digital image source, the edge determination element configured to supply an edge determination value to the determination phase element;
a minimum and maximum pixel determination element coupled to receive the applied digital image source and to determine a largest value and a smallest value of pixels contained in the kernel, the minimum and maximum pixel determination element configured to supply the largest value and the smallest value of pixels to the determination phase element; and
an initial threshold value determination element coupled to receive the applied digital image source and to determine an initial threshold value of the pixel under evaluation, the initial threshold value determination element configured to supply the initial threshold value to the determination phase element.

10. The noise filtering engine of claim 6 wherein the determination phase element comprises:
a special provisions element coupled to an output of the data collection phase; and
a determination phase threshold value determination element coupled both to an output of the data collection phase element and to an output of the special provisions element, the determination phase threshold value determination element configured to determine a threshold value of the pixel under evaluation, the determination phase threshold value determination element coupled to supply the initial threshold value to the application phase element.

11. The noise filtering engine of claim 6 wherein the application phase element comprises:
a smoothing function element coupled to an output of the determination phase element; and
a replacement element to replace a current value of the pixel under evaluation with a target value.

12. A noise filtering engine for enhancing an applied digital image source, the engine comprising:
data collection means for accepting the applied digital image source and determine characteristics of a pixel under evaluation, the pixel under evaluation being located within the digital image source;
determination means for accepting an output of the data collection means and determining whether the pixel under evaluation requires filtering; and
application means for accepting an output of the determination phase element and applying a smoothing function based upon characteristics of the pixel under evaluation, the application means producing an enhances digital image.

13. The noise filtering engine of claim 12 wherein the data collection means comprises:
mean determination means for receiving the applied digital image source and determining a mean value of an input kernel, the input kernel being selected from the applied digital image source and comprising the pixel under evaluation and neighboring pixels and;
median determination means for receiving the digital image source and determining a median value of the input kernel.

14. The noise filtering engine of claim 13 wherein the data collection means further comprises:
variance determination means for receiving an output from the mean determination means and calculating a variance value as an input to the determination means;
target determination means for receiving an output from both the mean determination means and the median determination means; and
weighted measurement value means for receiving the applied digital image source and an output from the target determination means and supplying a weighted measurement value as an input to the determination phase means.

15. The noise filtering engine of claim 12 wherein the data collection phase means comprises:
edge determination means for receiving the applied digital image source, determining whether the pixel under evaluation is part of an edge from an image contained within the digital image source, and supplying an edge determination value to the determination phase means;
minimum and maximum pixel determination means for receiving the applied digital image source, determining a largest value and a smallest value of pixels contained in the kernel, and supplying the largest value and the smallest value to the determination phase means; and
initial threshold value determination means for receiving the applied digital image source, determining an initial threshold value of the pixel under evaluation, and supplying the initial threshold value to the determination phase means.

16. The noise filtering engine of claim 12 wherein the determination phase means comprises:
special provisions for receiving an output of the data collection means; and
determination phase threshold value determination for receiving both an output of the data collection phase means and an output of the special provisions means, determining a threshold value of the pixel under evaluation, and supplying the initial threshold value to the application phase means.

17. The noise filtering engine of claim 12 wherein the application phase means comprises:
smoothing function means for receiving an output of the determination phase means and applying a smoothing function; and
replacement means for replacing a current value of the pixel under evaluation with a target value.
